(19) United States
(12) Patent Application Publication
(10) Pub. No.: US 2017/0346844 A1
(43) Pub. Date: Nov. 30, 2017

(54) Mitigating Multiple Advanced Evasion Technique Attacks

(71) Applicant: F-Secure Corporation, Helsinki (FI)

(72) Inventor: Daavid HENTUNEN, Helsinki (FI)

(21) Appl. No.: 15/604,730

(22) Filed: May 25, 2017

(30) Foreign Application Priority Data
May 27, 2016 (GB) 1609387.4

(51) Int. Cl. H04L 29/06; H04L 29/08

(52) U.S. Cl. CPC H04L 63/1425; H04L 63/166; H04L 63/0281; H04L 69/16; H04L 67/28

(57) ABSTRACT

Aspects of the invention relate to a method of identifying a potential attack in network traffic that includes payload data transmitted to a host entity in the network. The method includes: monitoring and checking said traffic on route to said host entity for intrusion attacks at a network entity acting as a proxy server; performing a first data-check on one or more data bytes of the payload data at the network entity acting as a proxy server; performing a second data-check, equivalent to the first data-check, on data of the network equivalent to the one or more bytes of payload data at a network entity acting as an Intrusion Detection System/Intrusion Protection System (IDS/IPS); and comparing the results of the first and second data-checks to determine if there is a mismatch, any mismatch being an indication that said step of monitoring and checking said traffic is unreliable.

### TECHNICAL FIELD

The present invention relates to the field of mitigating attacks in a computer security system, where the attack may employ multiple concurrent Advanced Evasion Techniques.

### BACKGROUND

Computer security systems have to contend with increasingly sophisticated attacks, or exploits from malicious persons (i.e. hackers) attempting to gain access to data or software in a computer. An Intrusion Detection System (IDS) is an information security device that monitors and analyses data to detect when security is breached, while an Intrusion Prevention System (IPS) is a device that identifies malicious activity and attempts to stop or block the activity. IDS and IPS devices are often integrated into an IDS/IPS or Intrusion Detection and Prevention System (IDPS).

Techniques of bypassing an information security device in order to deliver an attack to a target network entity without detection are known as evasions. Evasions are typically used to counter a network-based IDS/IPS but can also be used to by-pass firewalls. Just as viruses can be detected and blocked by anti-virus software, evasions can be stopped through anti-evasion solutions. However, it has recently been recognized that more advanced evasion techniques (AETs) have been developed, and it has been reported that most, if not all currently available IDS/IPS solutions are unable to detect or prevent an attack if more than one AET is used concurrently.

The present invention has been conceived with the foregoing in mind. However, before describing this further some explanation is required of the terms that will be used particularly in relation to the embodiments described.

An attack is any attempt to destroy, expose, alter, disable, steal or gain unauthorized access to or make unauthorized use of a computer asset. An exploit is a piece of software, a chunk of data, or sequence of commands that takes advantage of a bug, glitch or vulnerability in order to cause unintended or unanticipated behavior to occur on a computer. Examples might include gaining control of a computer system or allowing a privilege escalation or a denial of service attack. Malware is malicious software designed to secretly access a computer system without the owner's informed consent, and may include a variety of forms of hostile, intrusive, or annoying software or program code, such as computer viruses, worms, trojan horses, spyware, dishonest adware, scareware, crimeware, most rootkits, and other malicious or undesirable software.

As used herein, an attack may be considered also to include any of the above.

The term “vulnerability”, as used herein refers to the term defined by the Common Vulnerabilities and Exposures (CVE®). CVE defines a vulnerability as a mistake in software that can be directly used by a hacker to gain access to a system or network. CVE is a dictionary of identifiers of known vulnerabilities that makes it easier to share data across different network security databases.

Embodiments are described below in relation to network communications at certain levels, or layers, such as described in the ISO's Open Systems Interconnection (OSI) model. In the OSI model a layer is a collection of conceptually similar functions, implemented within each layer by one or more entities. Each entity interacts directly only with the layer immediately beneath it, and provides facilities for use by the layer above it. Protocols enable an entity in one host to interact with a corresponding entity at the same layer in another host. Most network protocols used today are based on TCP/IP stacks.

In at least one version of the 051 model there are seven layers. Starting at the lowest layer, layer 1, which is the physical layer, the layers above are, in order, 2—the data Link layer, 3—the Network layer, 4—the Transport layer, 5—the Session layer, 6—the Presentation layer, and 7—the Application layer. At any given layer, N, two entities (N-peers) interact by means of the N protocol by transmitting protocol data units (PDUs). A Service Data Unit (SDU) is a specific unit of data that has been passed down from one layer to a lower layer, and which the lower layer has not yet encapsulated into a protocol data unit (PDU) of its own layer. Thus, an SDU is a set of data that is sent by a user of the services of a given layer, and is transmitted semantically unchanged to a peer service user. The SDU is the ‘payload’ of a given PDU. Accordingly, where the embodiments described below refer to a particular level or layer, such as the Application level, to describe the principles of the invention, it should be understood that the same principles may be applied at other layers, and where data is referred to as payload it should not be construed as being limited to data at any particular layer.

U.S. Pat. No. 8,763,121 describes an example method of mitigating attacks in a computer security system, where the attack may employ multiple concurrent Advanced Evasion Techniques. However, an example method described in U.S. Pat. No. 8,763,121 does not enable protection of such end-point devices that have no possibility to use end-point protection software. For example, some ICS/SCADA devices with high real-time computing requirements, medical devices or military vehicles may require a solution where end-point protection software is not necessarily required for defending against such attacks.

### SUMMARY

According to a first aspect of the invention, there is provided a method of identifying a potential attack in network traffic that includes payload data transmitted to a target entity in the network. The method includes: monitoring and checking said traffic on route to said target entity for intrusion attacks, performing a first data-check on one or more data bytes of the payload data at a network entity acting as a proxy server, wherein an original TCP/IP (Transmission Control Protocol/Internet Protocol) part of the network traffic is removed and replaced with a TCP/IP generated by the proxy server before performing the first data-check, performing a second data-check, equivalent to the first data-check, on data of the network equivalent to the one or more bytes of payload data at a network entity acting as an Intrusion Detection System/Intrusion Protection System (IDS/IPS), wherein the original TCP/IP part is included in the network traffic, and comparing the results of the first and second data-checks to determine if there is a mismatch, any mismatch being an indication that said step of monitoring and checking said traffic is unreliable.

The first data-check may be performed by a proxy server and the second data-check performed by an IDS/IPS. The proxy server and the IDS/IPS may be comprised within separate network entities or within the same network entity. The proxy server may be provided with a communication channel to the IDS/IPS, the results of the first and/or the second data-check being transmitted over the communication channel for the comparing.

The first data-check may be performed on a server monitoring traffic relating to a service, the method further comprising performing a predetermined action in response to identification of a potential attack. The predetermined action may comprise terminating the connection, or logging the attack, or both.

The first and second data-checks may comprise calculating a checksum. The checksum calculation may be a sliding checksum with offset information. The second data-check may comprise calculating a sliding checksum both on traffic on route to the proxy server and on traffic passing through the proxy server.

The potential attack may be identified as an attack that might include a plurality of Advanced Evasion Techniques, AETs.

According to a second aspect of the invention there is provided a system for identifying a potential attack in network traffic that includes payload data transmitted to a target entity in the network comprising: a network monitoring device configured to monitor and check said traffic on route to the target entity for attacks; a first data-checker configured to perform a first data-check on one or more data bytes of the payload data, wherein an original TCP/IP (Transmission Control Protocol/Internet Protocol) part of the network traffic is removed and replaced with a TCP/IP generated by the proxy server before performing the first data-check, and wherein the first data-checker is comprised within a network entity acting as a proxy server; a second data-checker configured to perform a second data-check, equivalent to the first data-check, on data of the network equivalent to the one or more data bytes of the payload data, wherein the second data-checker is comprised within a network entity acting as an Intrusion Detection System/Intrusion Protection System (IDS/IPS) and wherein the original TCP/IP part is included in the network traffic; and a comparator for comparing results of the first and second data-checks to determine if there is a mismatch, the mismatch being an indication that results from said network monitoring device are unreliable.

The network monitoring device may be comprised within the Intrusion Detection System/Intrusion Protection System, IDS/IPS. The system may further comprise a communication channel connecting the network entities acting as the proxy server and the IDS/IPS.

According to another aspect of the invention there is provided a computer network entity. The entity comprises a data-check comparator configured to perform a comparison between a first data-check of at least a portion of a payload of network traffic destined for a target entity and a second data-check, equivalent to the first data-check, on data of the network traffic equivalent to the portion of the payload of network traffic and to signal that results of monitoring and checking said network traffic are unreliable if the data-check comparison indicates a mismatch between the first and second data-checks, wherein an original TCP/IP (Transmission Control Protocol/Internet Protocol) part of the network traffic is removed and replaced with a TCP/IP generated by the proxy server before performing the first data-check, and wherein the first data-check is performed by a network entity acting as a proxy server.

### BRIEF DESCRIPTION OF THE DRAWINGS

FIG. 1 is a schematic block diagram of a network entity showing data transfer paths.

FIG. 2 is a flow diagram illustrating a procedure for identifying a potential attack network traffic.

FIG. 3 is another flow diagram illustrating a procedure for identifying a potential attack network traffic.

FIG. 4 is a schematic block diagram of a network entity suitable for implementing some embodiments of the present invention showing data transfer paths.

### DESCRIPTION OF EMBODIMENTS

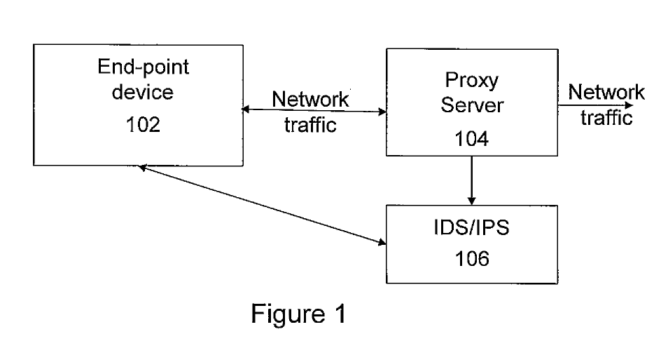

Referring to FIG. 1, a proxy server 104 resides as an entity in a network. The proxy server 104 sends and receives data in the form of network traffic to/from other entities, such as end-point devices 102, in the network. The network traffic is also monitored by an IDS/IPS 106. The proxy server 104 and IDS/IPS 106 have a dedicated communication channel open, which, in the embodiment shown, is a TCP channel (i.e. uses the TCP protocol). In an embodiment, also a so-called inline IDS that receives and forwards packets to their intended destination can be used. This means that instead of just passive monitoring of the network traffic, the network traffic goes through the inline IDS either unchanged or after modification.

The network traffic arriving at, or being sent by the proxy 104 is encapsulated as PDUs, the SDUs of which comprise the payload data. For example, the payload may be application level (layer 7) data, encapsulated in presentation layer (layer 6) PDUs that make up the network traffic.

Embodiments of the invention are based on the idea that the only way to be sure how an attack will manifest itself on a target computer is to inspect application level traffic payload on the target host itself. This is because it is the target computer that implements the specific TCP/IP stack particulars, and the ways that different attacks will then be interpreted by the target computer will only be evident from the payload at that level. However, for the IDS/IPS of the target network to perform the task of inspecting the payload data would involve a complex and CPU-intensive analysis of the PDUs involving exploit detection logic, and updating of databases. Instead, it is proposed to perform a simple comparison to check if the picture of the payload data in the traffic that is monitored by the IDS/IPS is the same as the actual payload at the target computer. If there is a discrepancy, it is an indication of a potential attack.

Thus, while the IDS/IPS does the actual attack detection from the application payload, the IDS/IPS is provided with feedback indicating if it has the correct picture of the application payload. If it doesn't, then a potential multi-AET attack is assumed to be in place.

An embodiment of the present invention solves the problem of detecting and preventing advanced evasion technique attacks without the need to install any software at the end-point device that is one communication party of the AET attack.

In an embodiment, one network element acts as a proxy server 104. All network traffic is passed through the proxy server 104. After the traffic has passed through the proxy 104, the original TCP/IP part of the traffic is removed and replaced with TCP/IP generated by the proxy itself. This in effect removes any AET tricks related to the TCP/IP part of the traffic. The proxy server 104 then calculates a sliding checksum for the payload portion of the newly created traffic passing through it. Then the IDS device 106 reassembles the original traffic passing through the proxy before it is given to the proxy and the IDS device also calculates a sliding checksum for the payload portion of the traffic. Finally both checksums are compared with each other and any differences may be treated as a sign of use of advanced evasion technique attacks.

In an embodiment, the IDS 106 may calculate a sliding checksum on both sides of the proxy server 104 for the original traffic as the traffic related to an AET attack can originate from either side of the device, from an infected LAN device or from a C2 server.

In an embodiment the same proxy server 104 may also act as an IDS device 106 or they can also be separate devices in the network.

In an embodiment, the proxy server 104 has a similar effect compared to an end-point device in a sense that it modifies the TCP/IP specifics of the traffic passing through it. This feature of the proxy in effect also removes the TCP/IP-related AET attacks. A similar effect may happen in the end-point device as the whole TCP/IP stack is removed.

Using the proxy server 104 has a real benefit in that protection of end-point devices is enabled even if the end-point devices have no possibility of having an end-point protection software in use.

According to one embodiment, the proxy server 104 has a configuration file that defines the type of connections that should be protected against a multi-AET attack. For example, the configuration file might include a list such as “HTTP, MSRPC, FTP, ARP, etc.”

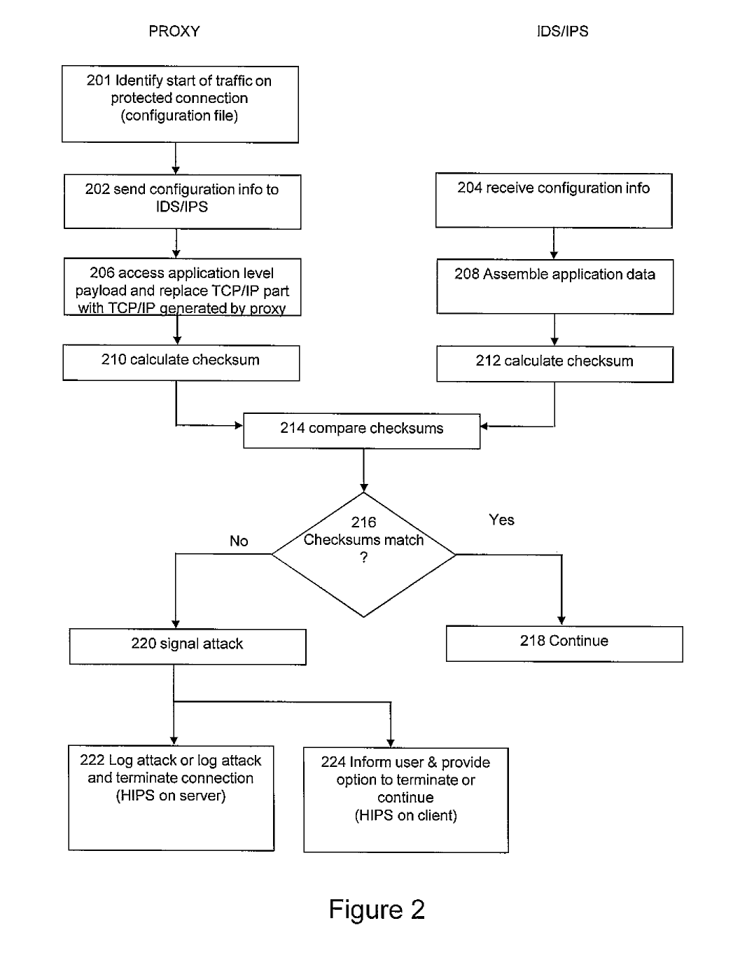

FIG. 2 illustrates the method of identifying a potential attack. The attack can originate from anywhere. For example, a host computer can be attacked or can also be used to attack other devices, like a server or an intermediate device. In FIG. 2, items shown on the left hand side are performed at the proxy server 104, while items shown on the right hand side are performed at the IDS/IPS 106. The procedure starts at step 201 where the proxy identifies from the configuration file that a communication is starting through one of the protected connections. Before any traffic is sent or received, at step 202, the proxy 104 sends the configuration file data to the IDS/IPS 106 through a communication channel, and this is received at step 204. Receipt of the configuration file acts as an indication that the proxy 104 and the IDS/IPS need to cooperate in the following procedure.

When traffic commences, at step 206, the proxy 104 accesses the application level payload bytes. The original TCP/IP part of the received traffic is removed and replaced with TCP/IP generated by the proxy 104 itself. The proxy 104 then performs a check on this newly created payload data, the result of which can be used to compare with a similar check performed on the equivalent, original traffic data that passed through the proxy 104 before it was processed by the proxy 104 and that is reassembled by the IDS/IPS. In this example, at step 210 a checksum of the payload data bytes is calculated. For example, this might be a sliding checksum with offset information.

At step 208, the IDS/IPS assembles the equivalent application level payload data bytes from the monitored network traffic, that is, data bytes equivalent with the original data that passed through the proxy 104 before the TCP/IP part removal and replacement with the TCP/IP generated by the proxy 104, and, at step 212 performs the same data check (i.e. checksum) calculation. In the IDS/IPS the application level data may be reassembled from data fragments in the PDUs of the network traffic.

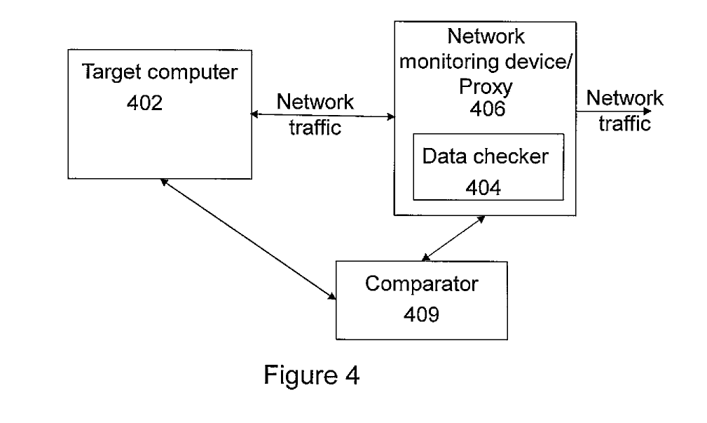

The results of the data checks performed by the proxy server 104 and IDS/IPS 106 can now be compared (step 214). For example, the proxy 104 may send the result of its checksum calculation over the communication channel 108 to the IDS/IPS 106, where the comparison is made. Alternatively, the IDS/IPS 106 could send the result of its checksum calculation to the proxy 104. As another alternative shown in FIG. 4, both the proxy 104 the IDS/IPS 106 could send the results of their checksum calculations to a checksum comparator 409 elsewhere in the network. On an on-going basis the checksums of the proxy 104 and IDS/IPS 106 are continuously compared for payload bytes at the same time as the bytes are exchanged over the connections specified in the configuration file.

If, at step 216, it is determined that the checksums calculated by the proxy 104 and the IDS/IPS 106 are the same, then no action need be taken and the process continues (step 218).

However, if at step 216, it is determined that there is a mismatch between the checksums, this is an indication of a potential attack, which could be using an AET, or possibly multiple AETs. At step 220 an attack is signaled (by whatever entity has performed the checksum comparison). In that case one of the following actions may be taken.

It will be appreciated that the IDS/IPS 106 continues to perform its normal functions of monitoring and checking for attacks. Also, once the checksum comparison at step 216 identifies a potential attack, the IDS/IPS 106 can proceed to identify the particular attack (AET) being used and take steps to nullify it.

If the proxy server 104 is inspecting traffic relating to some service, then a preconfigured action is taken at step 222 such as terminating the connection and logging the detected attack, or just logging it. Alternatively, if traffic to another network entity (e.g. some web site) is inspected, then at step 224 a prompt dialog is displayed on the client machine informing the client that it is probably being targeted. In that case, the user may be informed of the specific nature of the attack and given the option of either terminating the connection or accepting suspicious traffic. Alternatively, the system may be configured to automatically terminate the connection and notify the user accordingly.

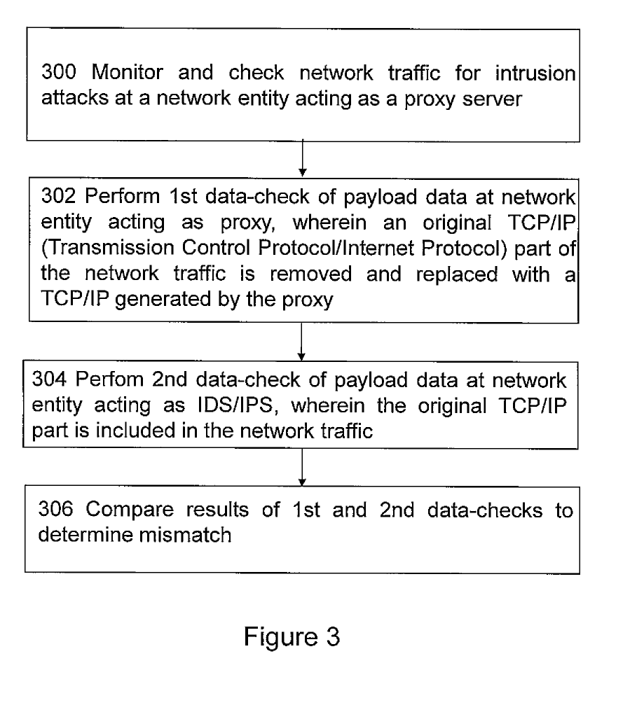

FIG. 3 is another flow diagram illustrating a procedure for identifying a potential attack network traffic. The method starts at 300 where network traffic is monitored and checked for intrusion attacks. In 302, a first data-check of payload data at a network entity acting as a proxy server is performed, wherein an original TCP/IP (Transmission Control Protocol/Internet Protocol) part of the network traffic is removed and replaced with a TCP/IP generated by the proxy server before performing the first data-check. In 304, a second data-check, equivalent to the first data-check, on data of the network equivalent to the one or more bytes of payload data at a network entity acting as an Intrusion Detection System/Intrusion Protection System (IDS/IPS) is performed, wherein the original TCP/IP part is included in the network traffic. Finally, in 306, the results of the first and the second data-checks are compared to determine any mismatch, where any mismatch being an indication that results of said step of monitoring and checking traffic is unreliable. Even though the example embodiments are described by using terms “a first data-check” and “a second data-check”, this does not mean that the data-checks would have to be performed in any specific order. The data-checks can happen in any order or also simultaneously depending on a specific embodiment.

FIG. 4 shows an example of network entities suitable for implementing the present invention. The network monitoring device 406 monitors and checks the network traffic for attacks. The data checker 404 is configured to perform a data check on one or more data bytes of the payload data of an incoming packet. The data checker 404 is also configured to perform a data check on an equivalent one or more data bytes of the network equivalent of the payload data. The comparator 409 compares the results of both data checks to determine if there is a mismatch, a mismatch being an indication that the results of the network monitoring device are inaccurate. It will be appreciated by a person skilled in the art that the data checks could be implemented in other systems, such as the data checker 404 being implemented in a HIPS, and network monitoring device 406 being implemented in an IDS/IPS as in the above embodiments.

The method described above mitigates and at least partially solves the problem of preventing attacks (exploits) that utilize multiple AETs. This is because the method nullifies AETs of a particular attack that exist on for example the TCP/IP stack level. As a consequence, only application level AETs remain available for the attacker and, depending on the application level protocol and the vulnerability in question, in most, if not all cases the attacker will be unable to utilize more than one AET at one time and so will be unable to evade the IDS/IPS. Thus, although an attacker might be able to use multiple AETs at the IP or TCP levels, for most vulnerabilities only one application level AET can be used.

The methods described above offer enhanced protection against multi-AET attacks and could be provided, for example, to Internet Service Providers as an optional or additional extra protection service for its customers. The IDS/IPS vendor will also obtain instant feedback on the type of any multi-AETs used that it has not detected. This information can then be used to develop the IDS/IPS technology further.

1. A method of identifying a potential attack in network traffic that includes payload data transmitted to a target entity in a network, the method including:
monitoring and checking said traffic on route to said target entity for intrusion attacks at a network entity acting as a proxy server;
performing a first data-check on one or more data bytes of the payload data at the network entity acting as a proxy server, wherein an original TCP/IP (Transmission Control Protocol/Internet Protocol) part of the network traffic is removed and replaced with a TCP/IP generated by the proxy server before performing the first data-check;
performing a second data-check, equivalent to the first data-check, on data of the network equivalent to the one or more bytes of payload data at a network entity acting as an Intrusion Detection System/Intrusion Protection System (IDS/IPS), wherein the original TCP/IP part is included in the network traffic; and
comparing the results of the first and second data-checks to determine if there is a mismatch, any mismatch being an indication that said step of monitoring and checking said traffic is unreliable.

2. The method of claim 1 wherein the network entity acting as a proxy server and the network entity acting as an Intrusion Detection System/Intrusion Protection System (IDS/IPS) are separate network entities.

3. The method of claim 1 wherein the network entity acting as a proxy server and the network entity acting as the Intrusion Detection System/Intrusion Protection System (IDS/IPS) are comprised within the same network entity.

4. The method of claim 1 wherein the results of the first and/or the second data-check being transmitted over a communication channel for the comparing.

5. The method of claim 1 wherein the data-checks are compared as the bytes are transmitted over the network.

6. The method of claim 1 wherein the first data-check is performed on a server monitoring traffic on a connection relating to a service, the method further comprising performing a predetermined action in response to the indication that said monitoring and checking step is unreliable.

7. The method of claim 6 wherein the predetermined action comprises terminating the connection, or logging the potential attack, or both.

8. The method of claim 1 wherein performing the first and second data-checks comprise calculating a checksum.

9. The method of claim 8 wherein the checksum calculation is a sliding checksum with offset information.

10. The method of claim 8 wherein the second data-check comprises calculating a sliding checksum both on traffic on route, to the proxy server and on traffic passing through the proxy server.

11. The method of claim 1 wherein the indication that said monitoring and checking step is unreliable is identified as an indication of an attack that may include a plurality of Advanced Evasion Techniques (AETs).

12. A system for identifying a potential attack in network traffic that includes payload data transmitted to a target entity in a network, the system comprising:
a network monitoring device configured to monitor and check said traffic on route to the target entity for attacks;
a first data-checker configured to perform a first data-check on one or more data bytes of the payload data, wherein an original TCP/IP (Transmission Control Protocol/Internet Protocol) part of the network traffic is removed and replaced with a TCP/IP generated by the proxy server before performing the first data-check and wherein the first data-checker is comprised within a network entity acting as a proxy server;
a second data-checker configured to perform a second data-check, equivalent to the first data-check, on data of the network equivalent to the one or more data bytes of the payload data, wherein the original TCP/IP part is included in the network traffic and wherein the second data-checker is comprised within a network entity acting as an intrusion Detection System/Intrusion Protection System (IDS/IPS); and
a comparator for comparing results of the first and second data-checks to determine if there is a mismatch, the mismatch being an indication that results from said network monitoring device are unreliable.

13. The system of claim 12 wherein the network monitoring device is comprised within the Intrusion Detection System/Intrusion Protection System, IDS/IPS, the system further comprising a communication channel connecting the network entities acting as the proxy server and the IDS/IPS.

14. A computer network entity comprising:
a data-check comparator configured to perform a comparison between a first data-check of at least a portion of a payload of network traffic destined for a target entity and a second data-check, equivalent to the first data-check, on data of the network traffic equivalent to the portion of the payload of network traffic and to signal that results of monitoring and checking said network traffic are unreliable if the data-check comparison indicates a mismatch between the first and second data-checks, wherein an original TCP/IP (Transmission Control Protocol/Internet Protocol) part of the network traffic is removed and replaced with a TCP/IP generated by the proxy server before performing the first data-check, and wherein the first data-check is performed by a network entity acting as a proxy server.
